(19) United States
(12) Patent Application Publication
(10) Pub. No.: US 2026/0259830 A1
(43) Pub. Date: Sep. 3, 2026

(54) EFFICIENT MODEL AGENT COMMUNICATION WITH CACHE SHARING

(71) Applicant: Microsoft Technology Licensing, LLC, Redmond, WA (US)

(72) Inventors: Esha CHOUKSE, Seattle, WA (US); Madanlal S. MUSUVATHI, Kirkland, WA (US); Shan LU, Bellevue, WA (US); Yuhan LIU, Chicago, IL (US)

(21) Appl. No.: 19/067,128

(22) Filed: Feb. 28, 2025

(51) Int. Cl. G06F 12/084

(52) U.S. Cl. CPC G06F 12/084; G06F 16/3349; G06F 40/284

(57) ABSTRACT

Example solutions for context sharing between GAI models includes: identifying a pair of GAI models including a first model and a second model; generating a first key-value (KV) cache of the first model; populating a second KV cache of the second model with one or more layers of the first KV cache; recomputing one or more other layers of the second KV cache; computing an output performance score for the second model based on a baseline metric; and transmitting a reuse pattern to a host device for use in context sharing between an instance of first model and an instance of second model, the reuse pattern identifying the plurality of first KV cache layers to be reused, thereby causing the host device to generate a local KV cache for the instance of second model by reusing the plurality of first KV cache layers from a KV cache of first model.

### BACKGROUND

Generative artificial intelligence (GAI) models, such as large language models (LLMs), are increasingly employed in complex workflows, where different LLMs and fine-tuned variants collaboratively address complex tasks. However, these systems face significant inefficiencies due to redundant context processing of shared context.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Aspects of the disclosure provide improved results in technical applications, such as in cybersecurity (e.g., where several fine-tuned models participate together in a security system to reason about the cause of a detected anomaly, whether it is indicative of malicious or benign behavior), in performing machine diagnostics (e.g., where several fine-tuned models participate in diagnosing faults and other issues in production or manufacturing machinery, vehicles, aircraft, computer systems, or the like), and in improvements in image processing (e.g., where several fine-tuned models participate to more accurate image classification, image segmentation, object detection, bounding box detection, and so forth).

Example solutions for context sharing between generative artificial intelligence (GAI) models include: identifying a pair of GAI models including a first model and a second model; generating a first key-value (KV) cache of the first model, the first KV cache including a plurality of first KV cache layers; populating a second KV cache of the second model with one or more layers of the first KV cache layers; recomputing one or more other layers of the second KV cache; computing an output performance score for the second model based on comparison between (a) at least one output generated by the second model while using the second KV cache and (b) a baseline metric; and transmitting a reuse pattern to a host device for use in context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model

### BRIEF DESCRIPTION OF THE DRAWINGS

The disclosed examples are described in detail below with reference to the accompanying drawing figures listed below:

FIG. 1 illustrates an architecture diagram of an example context sharing system within which multiple agents share model data;

FIG. 2 illustrates some internal components of an example generative artificial intelligence (GAI) model (e.g., an LLM or the like);

FIG. 3 illustrates a prefill phase and a decode phase used by the model during operation;

FIG. 4 is a graph that illustrates an example accuracy comparison of a few pairs of an example foundational model and its fine-tuned version on the specific tasks for which the fine-tuning was performed;

FIG. 5 is a graph that shows the impact of the length of the prefill phase on the end to end latencies of the system;

FIG. 6 illustrates the impact on accuracy when directly reusing the full KV cache from the baseline model on the fine-tuned model;

FIG. 7 includes graphs that illustrate the quality drop by reusing part of the KV cache from the baseline model;

FIG. 8 shows a violin plot of the normalized change in F1 score per input within a single dataset for an example model pair;

FIG. 9 illustrates an example transition point identified within a KV cache;

FIG. 10 illustrates the error brought by each transition point of E cache reuse;

FIG. 11 is a graph that illustrates the accuracy of selective reuse of critical layers versus selective reuse of a contiguous block of layers;

FIG. 12A is a graph that illustrates an example profiling output for the glue_sst2 and conllpp model pair;

FIG. 12B is a flowchart illustrating example operations for generating the graph shown in FIG. 12A, along with associated values;

FIG. 13 is an architecture diagram that supplements the context sharing system shown in FIG. 1;

FIG. 14A and FIG. 14B illustrate experimental results for evaluating context sharing between various pairs of models under the context sharing system of FIG. 1 and FIG. 13,

FIG. 15 illustrates the impact of arrival rate on time-to-first-token (TTFT), time-between-tokens (TBT), and end-to-end latency (E2E) when the context sharing system quality is same as full prefill;

FIG. 16 illustrates the impact of context length to the prefill latency of the context sharing system and the loading delay to fetch KV and E cache;

FIG. 17 illustrates using the recompute layers profiled on training datasets;

FIG. 18 illustrates prefill delay and accuracy trade-off for MAmmoTH2 fine-tuned for math reasoning tasks;

FIG. 19 illustrates the context sharing system as applied on Llama-3.1-70B-Instruct having higher accuracy than Llama-3-8B-Instruct;

FIG. 20 is a flowchart of an example method for context sharing between generative artificial intelligence (GAI) models; and

FIG. 21 is a block diagram of an example computing device (e.g., a computer storage device) for implementing aspects disclosed herein, and is designated generally as computing device.

Corresponding reference characters indicate corresponding parts throughout the drawings. Any of the figures may be combined into a single example or embodiment.

### DETAILED DESCRIPTION

Generative AI models (e.g., LLMs) have transformed the landscape of AI-driven applications, enabling a wide range of advanced capabilities, from natural language understanding to complex task automation. Further, the adoption of fine-tuned models is accelerating, driven by their ability to tailor foundational models for specific, niche tasks. Fine-tuning enhances model performance by, for example, adapting them to domain-specific datasets, enabling specialized applications across fields such as healthcare, legal reasoning, customer service, and creative content generation. Several services and prior work offer the ability to serve multiple fine-tuned models at once. At the same time, workflows increasingly integrate multiple model agents, each fine-tuned for distinct purposes. These agents collectively tackle complex, multi-step tasks, ranging from personalized user experiences to autonomous decision-making.

The fine-tuned models frequently share the same contexts in their inputs. For instance, personalized virtual assistants employ multiple models, each fine-tuned with a user's preference, but complement queries with shared contexts, such as a common knowledge database. In collaborative robotics, model-based agents coordinate task planning and execution by sharing real-time updates, as the shared context across the models. Similarly, enterprise-level customer support systems might deploy distinct agents, where each agent is fine-tuned for a different product category, thus leading to share the context of a customer's chat history (e.g., to seamlessly ensure consistency in user interactions).

This “shared context,” in conventional systems, leads to repetitive computations of embeddings and key-value (KV) caches, causing significant inefficiencies. For example, when two model inputs share a context as the input prefix, they each generate the embedding and KV caches of the same context during the prefill phase. However, the prefill phase is computationally intensive and can represent a majority of inference latency, particularly with long contexts. Further, this phase not only consumes substantial power but also reduces system throughput by delaying subsequent queries. These inefficiencies become a bottleneck when multiple fine-tuned models repeatedly process the same context independently, such as in conventional multi-agent workflows.

In contrast, a context sharing system and framework is described herein. In examples, the context sharing system is implemented between models (e.g., LLMs) that are derived from the same foundational model. This shared origin enables optimization of context sharing by reusing intermediate data, such as embeddings and KV caches, between models. The context sharing system selectively recomputes particular layers of KV caches while reusing other layers, thereby providing a balance between accuracy and efficiency. Through a detailed analysis of KV cache reuse patterns, described herein, the context sharing system only recomputes a subset of layers (e.g., those whose KV cache has a high impact on model outputs), thereby resulting in both performance inefficiencies and accuracy loss due to compounding errors caused by reused layers between recomputed layers. This system identifies contiguous chunks of reusable layers, ensuring only one transition from a reuse phase to a recomputation phase.

For example, the context sharing system and framework described herein provides a novel framework for efficient KV cache reuse across fine-tuned models. The context sharing system identifies critical layers through offline profiling, enabling sufficient recomputation while reusing as many non-critical layers as possible. By minimizing redundancy and optimizing transition points, the context sharing system achieves significant improvements in inference latency and system throughput while maintaining high accuracy.

The context sharing system optimizes context sharing between fine-tuned models derived from the same foundational model by identifying layers in the KV cache and selectively recomputing those layers, enabling efficient reuse of intermediate data while maintaining high accuracy. The context sharing system thus balances computational efficiency and task fidelity, significantly reducing interference latency and throughput bottlenecks. Experiments on diverse datasets and model pairs demonstrate that this context sharing system achieves significantly higher throughputs (e.g., by a factor of three in some examples) as well as significantly faster prefill times (e.g., by a factor of 2.6 in some examples) with negligible accuracy loss compared to full recomputation.

One example application of some aspects of the disclosure is cybersecurity. In GAI-supported cybersecurity, it is particularly important to have GAI models that are fine-tuned for specific tasks, and that can work together to identify security issues. For example, in one application, a fine-tuned model is used in a security system to reason about the cause of a detected anomaly, or whether it is indicative of malicious or benign behavior. In such applications, a decision or conclusion made by the fine-tuned model triggers a security action autonomously. In some situations, the context of one model may be shared with another model that is fine-tuned for another task, such as causing a suggested or recommended action to be outputted (e.g., via a user interface, such as a graphical user interface), which is performed in response to user input confirming the action. Examples of security actions include isolating, quarantining, or restricting an entity (e.g., device, user account, file, document, application, process, service, or the like) within a network or other system.

Other example applications include the use of fine-tuned models to work together to perform machine diagnostics, such as diagnosing faults and other issues in production or manufacturing machinery, vehicles, aircraft, computer systems (e.g., computers, user devices, servers, data centers), and the like.

Another example application is computer vision, such as image processing or processing of ‘visual’ spatial sensor data more generally (e.g., lidar, radar, and so forth). Conventional computer vision is based on statistical pattern recognition. For example, previous advances in computer vision have been driven by learned features in convolutional neural network architectures. However, improvements in image processing (e.g., more accurate image classification, image segmentation, object detection, bounding box detection, and so forth) can be achieved through use of multiple models that are capable of reasoning about the visual contents of an image captured in its pixel values or analyzing such images or data in particular ways. Specific examples include medical imaging and diagnostics based on physiological sensor measurements, where collaboration between various fine-tuned models translates to improved diagnostics.

Another example application is signal processing, such as processing of audio data or other forms of sensor data. The same principles as described in the previous paragraphs apply equally to the processing of other types of functional data, such as audio data, motion sensor data, physical measurements collected in a technical system (e.g., manufacturing system, vehicle, aircraft, or other machines), physiological measurements collected from a human or other living being (e.g., to support a diagnostics application).

While some examples are described with reference to GAI models, LLMs or language models (LMs), aspects of the disclosure are not limited to operating with these kinds of models. Rather, aspects of the disclosure are operable with any kind of transformer-based generative model or decoder-only transformer-based generative model. Further, while some examples areas described with reference to a KV cache, aspects of the disclosure are not limited to operating with this specific data structure. Rather, aspects of the disclosure are operable with any kind of intermediate data, including other data structures such as any kind of database, memory grid, graph, or hierarchical storage system.

Additional technical details, examples, and technical benefits are described below with regard to the figures.

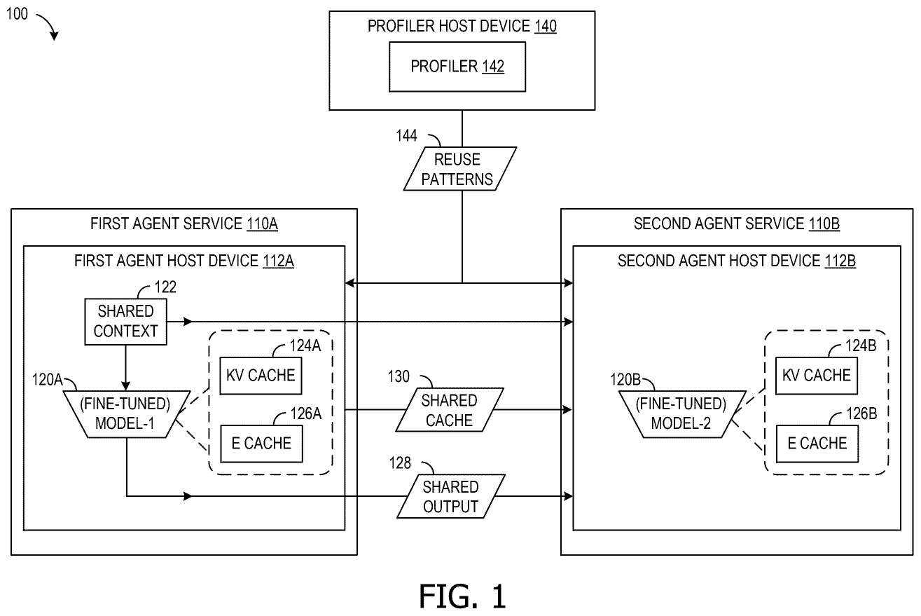

FIG. 1 illustrates an architecture diagram of an example context sharing system 100 within which multiple agents share model data during operation. In the example, the agent system 100 includes two agent services that work together (e.g., share particular data to perhaps provide a related service). More specifically, a first agent service (or “upstream service”) 110A utilizes model-1 120A to provide some model-based service or operations, and a second agent service (or “downstream service”) 110B utilizes another model, namely model-2 120B, to provide some other model-based service or operations.

For example, in one use case, the context sharing system 100 is configured to perform medical diagnosis and treatment planning, where the first agent service 110A and associated model-1 120A is configured to review the medical history of a patient (e.g., lab test results, symptoms, and so forth) and generate a preliminary diagnostic hypothesis, and the second agent service 110B and associated model-2 120B is configured to use the hypothesis to recommend treatment options, generate patient instructions, identify potential risks or contradictions, and so forth. In another use case, the context sharing system 100 is configured to perform document review and summarization, where the first agent service 110A is configured to process legal, technical, or scientific document, extract key sections, and provide a summary or annotations for context, and the second agent service 110B is configured to refine the summaries, perform sentiment analysis, or evaluate compliance with specific standards or requirements based on the extracted context. In another use case, the context sharing system 100 is configured to perform threat detection and mitigation in cybersecurity, where the first agent service 110A is configured to analyze logs and alerts from cybersecurity systems to identify potential threats, and the second agent service 110B is configured to recommend or implement mitigation strategies, such as adjusting firewall rules or alerting human operators.

In examples, these models 120A, 120B are generative artificial intelligence (GAI) models (e.g., text generation models such as LLMs, image, video, or audio generation models, code generation models, multimodal models, or the like), either or both of which are a “baseline” model of some particular architecture or some fine-tuned variant that baseline model. In other words, both models 120A, 120B share an architecture, where a baseline model is the “non-fine-tuned” version of that architecture, and where a fine-tuned variant of that baseline model builds upon the baseline model by undergoing some additional training on a specific dataset tailored to a particular domain, task, or use case, thereby enabling the fine-tuned variant to produce more accurate and contextually relevant outputs for some particular use case. Thus, fine-tuned models inherit the foundational capabilities of the baseline model but enhance their performance by aligning their outputs more closely with specific requirements, creating a relationship where the baseline model provides the general framework and the fine-tuned variant specializes the baseline model for precision in some targeted application. As such, in these examples, each model 120A, 120B is fine-tuned for the particular task(s) performed by its associated service 110A, 110B, respectively, and is a fine-tuned variant of the same baseline model (not separately shown in FIG. 1).

In the example, during operation, the upstream model 120A shares several components of data with the downstream model 120B. More specifically, the upstream model 120A shares context data (shown here as “shared context 122”) with the downstream model 120B. Context data refers to the input provided to GAI models such as models 120A, 120B that frames the current task or interaction. Context data typically includes the information used by the model to understand the problem, generate relevant responses, and maintain coherence. Such context data can vary based on the particular application, but typically consists of task specific information (e.g., details about the task or query, such as a question, command, or instruction), background information (e.g., supporting details or relevant prior knowledge that helps the model respond effectively), history of interaction (e.g., previous exchanges or dialogue in a session, used to ensure continuity and coherence in response), external data (e.g., supplementary content or raw data, such as documents, tables, or records, that the model must analyze or process), metadata or instructional prompts (e.g., guidance on how the model should behave, such as tone, style, or specific formatting). During operation, the downstream agent service 110B uses the shared context 122 provided by the upstream agent service 110A (e.g., as a portion of an input context provided to model-2 120B, helping direct the task performed by that model-2 120B by providing some of the same data used by the upstream model 120A).

The upstream model 120A also shares output data (shown here as “shared output 128”) with the downstream model 120B. Output data refers to the response generated by the model during operation based on the input (e.g., context data) it receives. The output data is the data product generated by the model, tailored to the given task or query, and can take various forms depending on the capabilities of the model and the given task, such as medical summaries, code snippets, threat alerts, or the like. During operation, the downstream agent service 110B uses the shared output 128 provided by the upstream agent service 110A (e.g., as a portion of input context provided to model-2 120B during a query, such as asking model-2 120B to analyze a preliminary diagnostic hypothesis when generating recommend treatment options for a patient, or the like).

In addition to the shared context 122 and shared output 128, in examples, the upstream agent service 110A also shares aspects of cache data (shown here as “shared cache 130”) with the downstream agent service 110B. During operation, each individual model 120A, 120B utilizes a local Key-Value (KV) cache 124A, 124B, respectively, as well as an individual embedding (E) cache 126A, 126B, respectively. A KV cache 124 is a mechanism used in transformer-based models to store and reuse intermediate representations (e.g., keys and values) from previous computations in an input sequence. An E cache 126 is a storage mechanism used to save precomputed embeddings for specific inputs, such as words, phrases, or other data elements. In various examples, the context sharing system 100 provides features that allow sharing of data between these models 120A, 120B that improve aspects of computational efficiency, as described below. In this example, to improve computational efficiencies of the context sharing system 100, the upstream agent service 110A shares some cache data with the downstream agent service 110B (e.g., the shared cache 130). For example, some or all of the KV cache 124A or E cache 126A of the upstream model 120A, which were calculated and used during operation of model-1 120A, are transmitted to the downstream agent service 110B and reused by the downstream model, model-2 120B. If KV cache 124A can be shared between models 120A, 120B, then the prefill computation on the could be reduced for the downstream model 120B. For this particular example, instead of storing different versions of KV cache for different models (e.g., KV cache 124A for model-1 120A and KV cache 124B for model-2 120B), the system 100 computes and stores the KV cache 124A for one model version (e.g., model-1 120A) and then reuses that same KV cache 124A across different models 120 (e.g., as shared data 130 sent to model-2 120B, thus becoming KV cache 124B).

To determine what cache data is to be the shared cache 130 between the models 120A, 120B, in examples, the context sharing system 100 provides a profiler 142. The profiler 142, executing on a profiler host device 140, is configured to identify which types of models are being used by the agent services 110A, 110B and to send a reuse pattern 144 to the services 110A, 110B. The reuse pattern 144 identifies which portions of KV cache 124A from the upstream model 120A are to be reused by the downstream model 120B. In examples, the models 120A, 120B are transformer-based models that architected in multiple layers, and each layer has its own KV cache. As such, all of the KV caches of all of the layers of the particular model are referred to herein collectively as KV cache 124. The reuse pattern 144 identifies which layers of the KV cache 124A are to be reused by the downstream model 120B. As such, the remaining layers of the KV cache 124B are recomputed during operation of the downstream model 120B.

The operations of the profiler 142, the generation of the reuse patterns 144, and the sharing and reuse of KV cache 124 between the models 120A, 120B is described in greater detail below. While the context sharing system 100 is shown with two different host devices 112A, 112B executing their respective models 120A, 120B, it should be understood that other architectures (e.g., single host device executing multiple models, any number of models 120A, host devices 112, and/or agent services 110) are possible and within the scope of this disclosure.

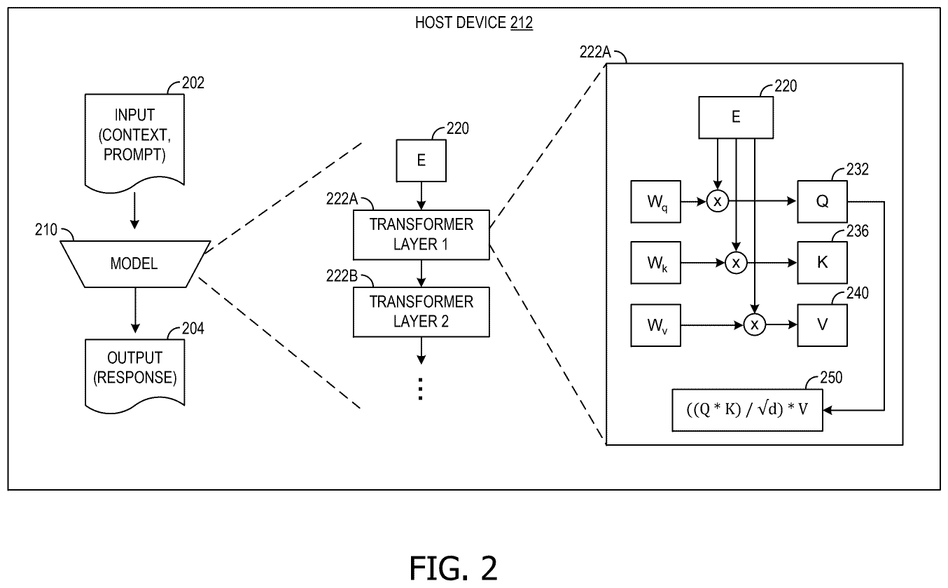

FIG. 2 illustrates some internal components of an example GAI model (or just “model”) 210 (e.g., an LLM or the like). In examples, the model 210 may be similar to the models 120A, 120B shown in FIG. 1. In the example, the model 210 is a transformer-type model (e.g., based on a self-attention mechanism) such as an LLM, that takes an input 202 (e.g., a context, a prompt, or the like) and generates an output 204 (e.g., a response, result, or the like, in the form of text, images, audio, programming code, values, or the like). In this example, the model 210 is executed on a host device 212, namely a computing device or computing system (e.g., physical machine, virtual machine, server, cluster, compute instance, cloud computing system, or the like) that is configured to implement the model 210 (e.g., perform the storage and computational operations associated with model loading, tokenization, input preparation, inference, decoding, post-processing, resource management, communication, and the like), and it is presumed that the host device 212 either performs such operations itself, including the various operations described herein, or uses other such computing resources to perform those operations.

In the example, the model 210 includes one or more of an encoder and a decoder (not separately shown), and the model 210 implements a self-attention mechanism that utilizes several core components shown in FIG. 1. More specifically, the model 210 includes an Embeddings component (E) 220, a Query component (Q) 232, a Key component (K) 236, a Value component (V) 240. The Embeddings component (E) 220 is a dense vector representation of input tokens that maps discrete tokens (e.g., words) into continuous vector spaces, capturing syntactic and semantic relationships between tokens. The Query component (Q) 232 represents a vector of the current token to seek relevant information from other tokens in the input sequence. The Key component (K) 236 encodes attributes of the available data to determine its importance relative to the query. The Value component (V) 240 contains the actual data or representation that is being passed along.

The model 210 consists of several layers, namely transformer layers 122, where each layer 122 includes its own Q 230, K 236, V 240, and E 220. For example, the Llama-3.1-70B model has 80 layers. The K 236 and V 240 vectors are collectively referred to herein as “KV cache,” and the embedding E 220 vector is referred to herein as “E cache.” Within each layer 122, embeddings E 220 are the starting point for subsequent transformer computations. They will be projected into tensors Q 230, K 236, and V 240 at the beginning of the attention mechanism. FIG. 1 illustrates how these components are used across layers 122. The quality of embeddings directly affects the ability of the model 210 to understand and process the input context effectively.

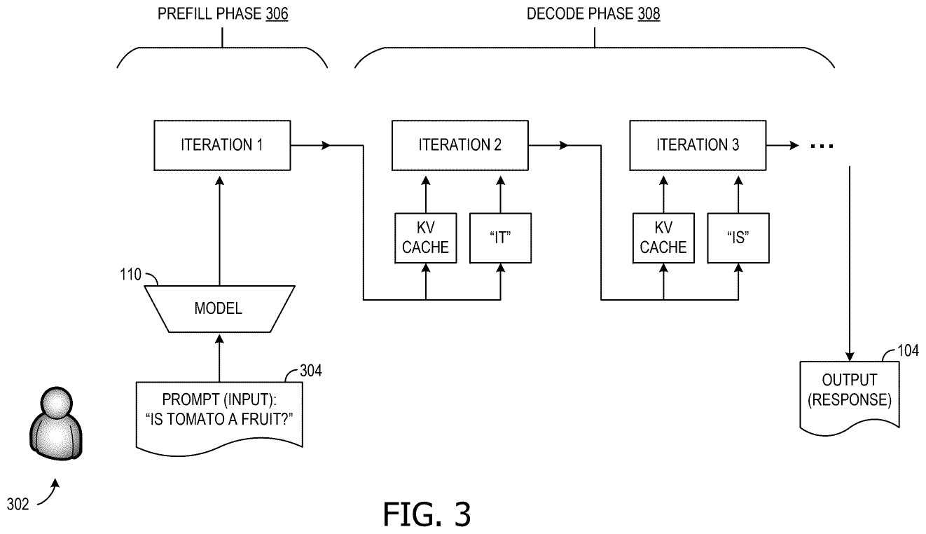

FIG. 3 illustrates a prefill phase 306 and a decode phase 308 used by the model 210 during operation. In the example, the model 210 is an LLM that processes input and generates output in two distinct phases, namely the prefill phase 306 and the decode phase 308. As shown in FIG. 3, a user 302 has provided a prompt 304 that is submitted as input (e.g., input 202, a query “Is tomato a fruit?”) to the model 210.

In the prefill phase 306, the model 210 processes the entire input context to compute the embeddings (E) 220 and the KV caches for each token. This phase involves the application of the attention mechanism of the model 210 across all layers 122 and the storage of intermediate representations that encode the input context (e.g., prompt 304, as well as any additional context that may be included). The prefill phase 306 is computationally intensive, with its complexity scaling quadratically with the input length, making it the dominant contributor to interference latency in long-context scenarios.

In the decode phase 308, the model 210 uses the cached representations (e.g., KV cache) generated in the prefill phase 306 to sequentially produce tokens (e.g., tokens 214) one by one as the output (e.g., output 204). This avoids the need to reprocess the entire context. As a result, the decode phase 308 has significantly lower computational overhead compared to the prefill phase 306, with its complexity scaling linearly with the output sequence length.

The main metrics used to capture the performance of the model 210 are time to first token (TTFT) (e.g., the duration from query submission to the generation of the first token, measuring the query's queuing delay and the prefill phase duration), time between tokens (TBT) (e.g., the average time between two generated tokens), end-to-end latency (E2E) (e.g., the duration from the query submission to the generation of the last token), and goodput (e.g., the throughput supported by the system while still meeting any particular service-level objectives).

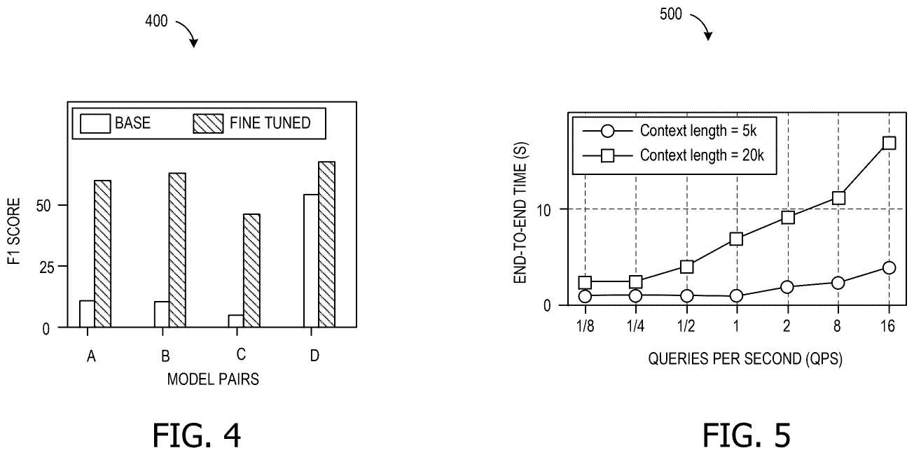

FIG. 4 is a graph 400 that illustrates an example accuracy comparison of a few pairs of an example foundational model and its fine-tuned version on the specific tasks for which the fine-tuning was performed. Fine-tuning adapts models such as the model 210 to specific tasks or domains, optimizing their performance for nuanced and specialized queries. For example, a fine-tuned customer support model handles troubleshooting requests with greater accuracy, while legal assistant benefits from training on case law and statutes. Further, low-rank adaptation (LoRA) introduces a lightweight and efficient approach to fine-tuning. Instead of modifying all model parameters, LoRA applies low-rank updates through parameter adapters, reducing computational and memory overhead. In the example, the four model pairs are Llama-3-70B-Instruct vs Llama-3-70B, Mistrallite vs Mistral-7B, Llama-3-8b-Instruct vs Llama-3-8B, and MAmmoTH2 vs Llama-3-8B, respectively. The fine-tuned model gives higher accuracy than the baseline version.

Given the distinct features of the prefill phase 306 and decode phase 308 discussed above, long prefill phases 306 tend to reduce the overall goodput of the system. Further, TTFT super-linearly increases with the length of the input. Long prefill phases 306 also create delays that ripple into the token generation process due to scheduling challenges. FIG. 5 is a graph 500 that shows the impact of the length of the prefill phase on the E2E latencies of the system. Longer inputs can lead to much longer end-to-end latency than shorter inputs.

Described herein are the properties and patterns observed around various examples of KV cache sharing across different models. A benchmark is provided for evaluation of the various examples. This study uses pairs of models that share the context provided by the datasets. The following assumptions are also made when building the benchmark. (A) The pair of models share the same foundational model. Specifically, the pair can either consist of the foundational model and a fine-tuned model based on it, or, two fine-tuned models based on the same foundational model. (B) The selected dataset is related to the task for which one of the models has been fine-tuned. This is important since in any context-sharing scenario, the fine-tuned model is performing the specialized task. (C) The fine-tuned model is fine-tuned on the task in the corresponding dataset should yield better accuracy on the dataset than the other model in the pair, and thus may be referred to herein as a “specialized model.”

Below is a table of model pairs used to evaluate various examples of context sharing (e.g., KV cache sharing) described herein:

TABLE 1
Model Pairs

| Fine-tuned Model | Baseline Model |
|---|---|
| glue_sst2 | conlpp |
| gsm8k | glue_stsb |
| phi-3.5-mini-instr-adapter | phi-3.5-mini-instr-task15 |
| phi-3.5-mini-instr-adapter-v2 | phi-3.5-mini-instr-task15 |
| llama-3-8b-sft-lora-ultrachat | fingpt-llama-3-8b |
| llama-3-8b-chat-lora | fingpt-llama-3-8b |
| mistrallite | mistral-7b |
| llama-3.1-70b-instruct | llama-3.1-70b |

Further, three datasets are used for this benchmark across all the pairs, namely HotpotQA, multifieldQA_en, and 2wikimQA. The quality or accuracy metric used is taken directly from the dataset.

Although several use cases are discussed herein, this example focuses on the use case where the baseline model generates the intermediate state for the context and the fine-tuned model reuses its intermediate states, with both models deployed on separate nodes (e.g., host devices 112A, 112B). The context-generator model is referred to herein as the baseline model, and the context-user model as the fine-tuned model. In other examples, both model pairs are fine-tuned variants of the same underlying baseline model. In some examples, the fine-tuned model(s) are more accurate than the underlying baseline model.

In some examples, the context sharing system 100 reuses the entire KV cache of the baseline model on the fine-tuned model. In this example, reusing the whole KV cache between models leads to a significant loss in accuracy. A naïve way to reuse the intermediate state between models is to reuse the KV cache as is. In this case, the fine-tuned model receives the KV cache for the whole input prompt from the baseline model. It then uses this to generate the output tokens in the decode phase, thereby completely skipping the prefill phase.

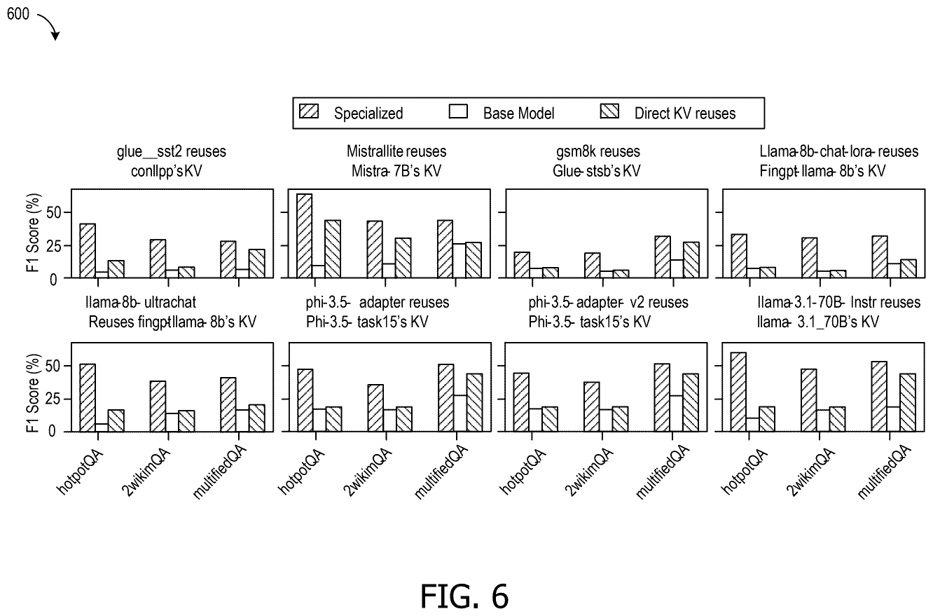

FIG. 6 illustrates the impact on accuracy when directly reusing the full KV cache from the baseline model on the fine-tuned model. For each pair of models and dataset, the graphs of FIG. 6 show the F1 score (where higher is better) of (a) the fine-tuned model (e.g., using its own KV cache), (b) the fine-tuned model while reusing the KV cache generated by the baseline model, and (c) the baseline model alone. Although the accuracy of the fine-tuned model with the KV cache of the associated baseline model is still better than the baseline model alone, there is a significant loss in accuracy (e.g., when comparing (b) the KV cache reuse to (a) the fine-tuned model using its own KV cache). HotpotQA tends to lose more than 50% of the accuracy points across all pairs, while the other datasets show varying amounts of changes across model pairs.

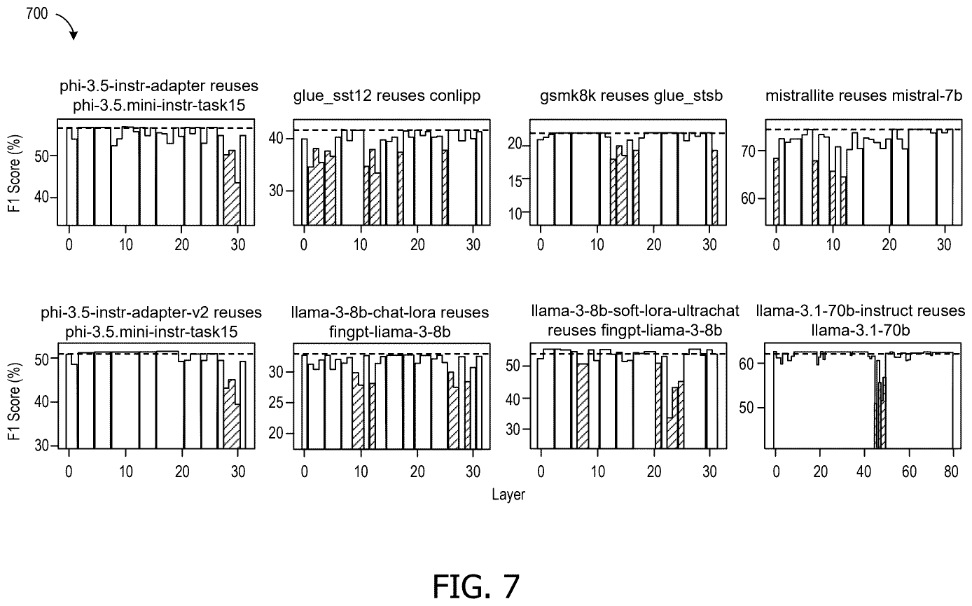

FIG. 7 includes graphs 700 that illustrate the quality drop by reusing part of KV cache from the baseline model (e.g., as in scenario (b) described above). Different layers have different sensitivities to deviation in KV cache. The graphs 700 of FIG. 7 are plotted by reusing only one layer's KV cache from the base model on the fine-tuned model. The red dashed line is the original accuracy of the fine-tuned model (e.g., the specialized model). The bars colored red are those that have an F1 score drop of over 10% compared to the original fine-tuned model.

More specifically, each bar represents the quality achieved by the fine-tuned model when reusing the KV cache for that corresponding layer from the associated baseline model, with everything else being recomputed. For most of the model pairs, only a small subset of layers are sensitive to the deviation in KV cache (e.g., F1 score drops significantly). As such, these layers are referred to herein as “critical layers,” (colored by red in FIG. 7). On average across all pairs of models, approximately 11% of layers are identified to be critical in this example. Reusing the KV cache from one layer of the baseline model is, at a high level, analogous to freezing the baseline model's weights for that layer. Reusing the KV cache for non-critical layers, similar to freezing these non-critical layers, will have less impact on the output compared to reusing KV for critical layers.

In examples, the critical layers are scattered in different parts of the models. This is consistent with the idea that the layers that contribute the most to the accuracy improvement after finetuning may reside in any part of the models. Specifically, the variation in KV cache patterns across inputs is only notable for critical layers.

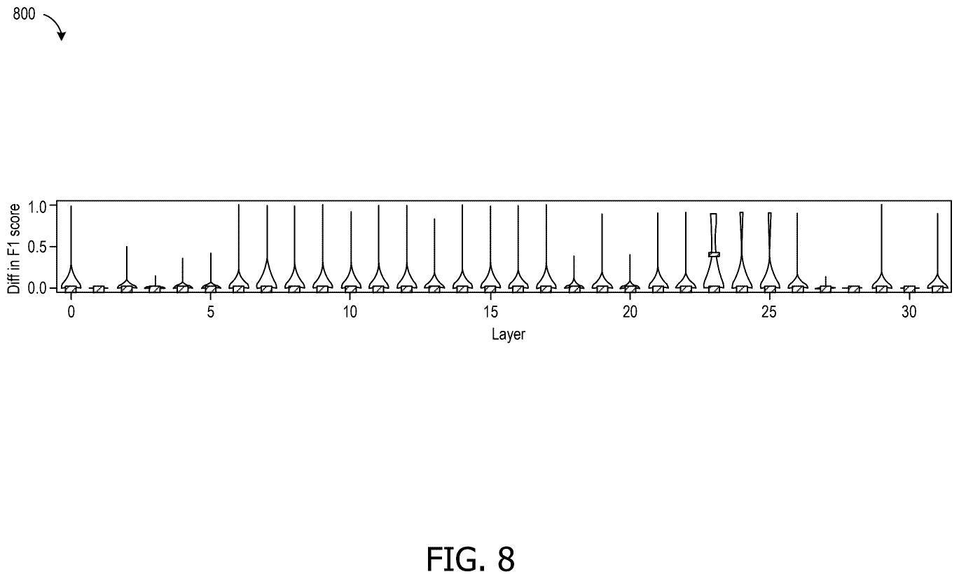

FIG. 8 shows a violin plot of the normalized change in F1 score per input within a single dataset for an example model pair. More specifically, FIG. 8 shows a violin plot of normalized change in F1 score per input in hotpotQA dataset, when llama-3-8b-sft-lora-ultrachat reusing fingpt-llama-3-8b's KV cache of each layer only. Variation in F1 score per input is plotted for the 25 and 75 percentiles. Except layer 23, the 25 and 75 percentiles overlap, indicating a low variance of error sensitivity across all layers except layer 23. Layer 23, which is also marked as the most critical for this model pair in FIG. 7 (e.g., the largest F1 score change), shows a wider variation across different data points from the dataset, with a lot of them observing F1 score change greater than 50%. However, for all the non-critical layers, the variance in the F1 score change is insignificant, meaning that such non-critical layers do not change across various inputs.

Returning again to the context sharing system of FIG. 1, and building on the insights described above, the system 100 is designed to enhance the context sharing between the two models 120A, 120B. One important target is maximizing reuse of KV cache to improve computational efficiency gains while keeping the accuracy loss minimal. Selecting all critical layers scattered across different parts of the model is suboptimal for both efficiency and accuracy. Recomputing critical layers that are non-contiguously placed is inefficient. Further, some examples use the E cache from the baseline model as a proxy to start the recomputing at the layer when transitioning from KV cache reuse to recompute. This layer is referred to herein as the transition layer.

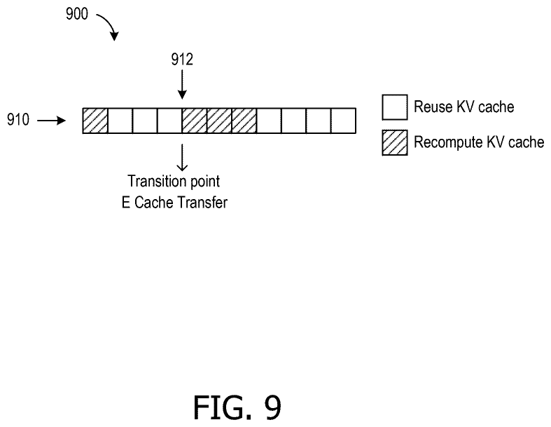

FIG. 9 illustrates an example transition point 912 identified within a KV cache 910. As illustrated in FIG. 9, for any layer to switch between reuse and recompute, the baseline model stores and transmits the E cache to the specialized model. The E cache is typically large, reaching up to twice the size of the KV cache for the Mistral-7B or Llama-3-8B model families, and up to four times larger for the Llama-3.1-70B model family since the KV cache size is optimized by groupquery attention. Consequently, the overhead of storing the E cache in GPU memory and the delays caused by loading it from remote GPU nodes can be substantial, far exceeding the cost of storing and transmitting the KV cache alone.

Furthermore, reusing the E cache of the baseline model at the transition layer 912 might also hurt the accuracy of the final output. This is because the E cache loaded from the baseline model (starting point of the recomputation) already differs from the specialized model. Such difference eventually will introduce deviation from the point of recomputation and propagate over all later layers. If all the critical layers are selected, which may not appear in contiguous chunks (e.g., as shown in FIG. 7), there will be multiple transition layers from reuse to recompute, introducing multiple deviations in E cache.

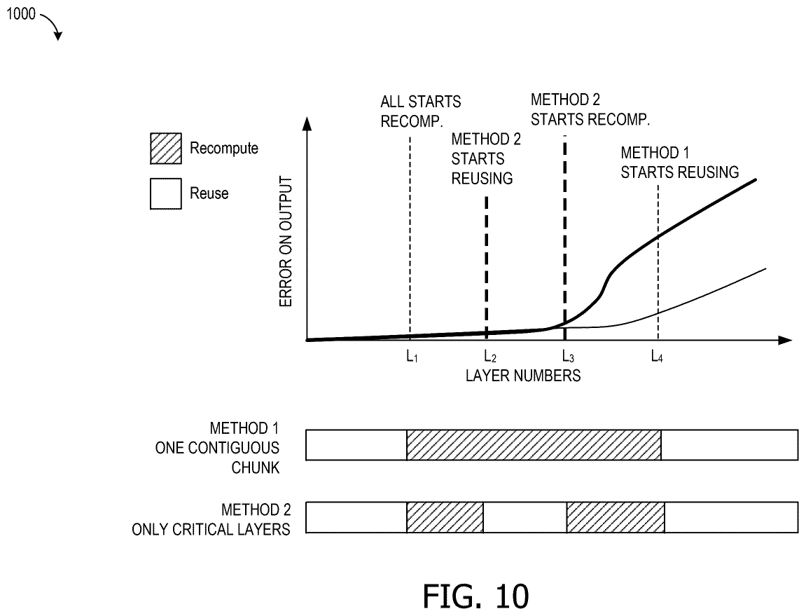

FIG. 10 illustrates the error brought by each transition point of E cache reuse. If the system 100 recomputes only critical layers (e.g., layers L1 to L2, and L3 to L4 of FIG. 10, referred to as “method 2” in FIG. 10), the system 100 needs to load E cache at layer L1 and L3. However, whenever the system 100 loads E cache, the error from E cache will be populated to subsequent critical layers (e.g., loading E cache at layer L3 populates errors to L3-L4) and eventually to the output. Thus, even if all critical layers are recomputed, this will lead to a substantial output error.

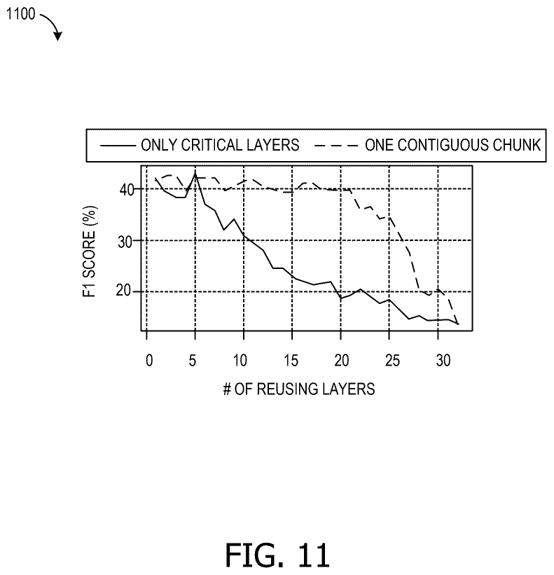

In contrast, recomputing a contiguous chunk of layers from L1 to L4 (referred to as “method 1” in FIG. 10) avoids this problem by recomputing the KV cache of non-critical layers that are located between critical layers. Confirming this, the accuracy of recomputing a contiguous block of layers versus recomputing the same number of critical layers based on importance is compared. FIG. 11 is a graph that illustrates the accuracy of selective reuse of critical layers versus selective reuse of a contiguous block of layers. The latter approach consistently underperforms due to loading multiple E caches from multiple transitions.

To address the challenges of selective KV cache reuse, a focus is placed on minimizing the number of loaded E caches from the baseline model. For example, the system 100 identifies a single transition point of reuse→recompute, similar to method 1 shown in FIG. 10. This design choice balances efficiency and accuracy by limiting the overhead associated with transmitting E cache across multiple transitions and reducing the errors introduced by loading deviated E cache multiple times. The reuse patterns are formulated to be recompute→reuse→recompute→reuse, which leads to at most one transition point from reuse to recompute (e.g., requiring only one-time loading of E cache). The system 100 also considers two special cases of the aforementioned formulation, namely: recompute→reuse→recompute, and reuse→recompute→reuse.

The examples provided herein profile each pair of models to determine the contiguous blocks of critical layers, with a goal being to minimize block size with high accuracy to ensure maximizing performance gains from reuse.

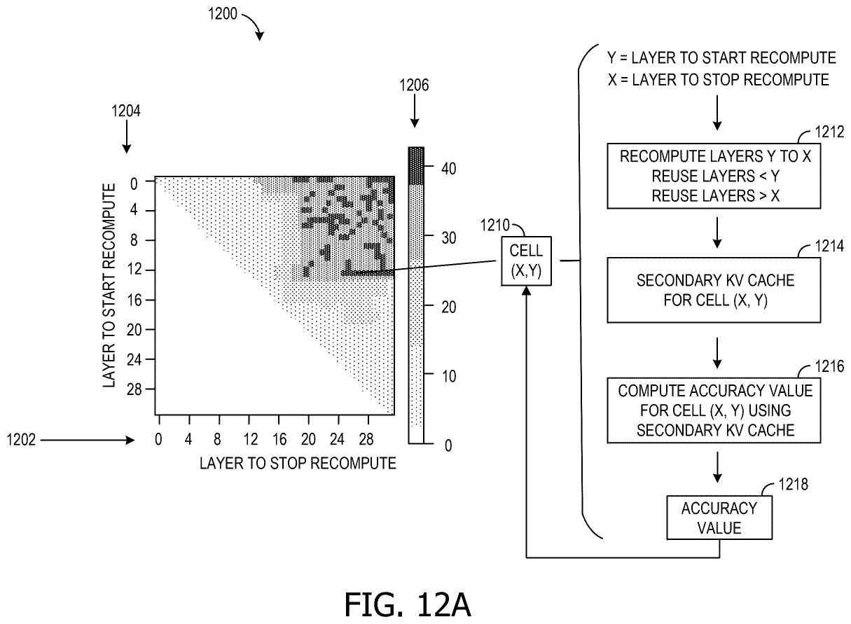

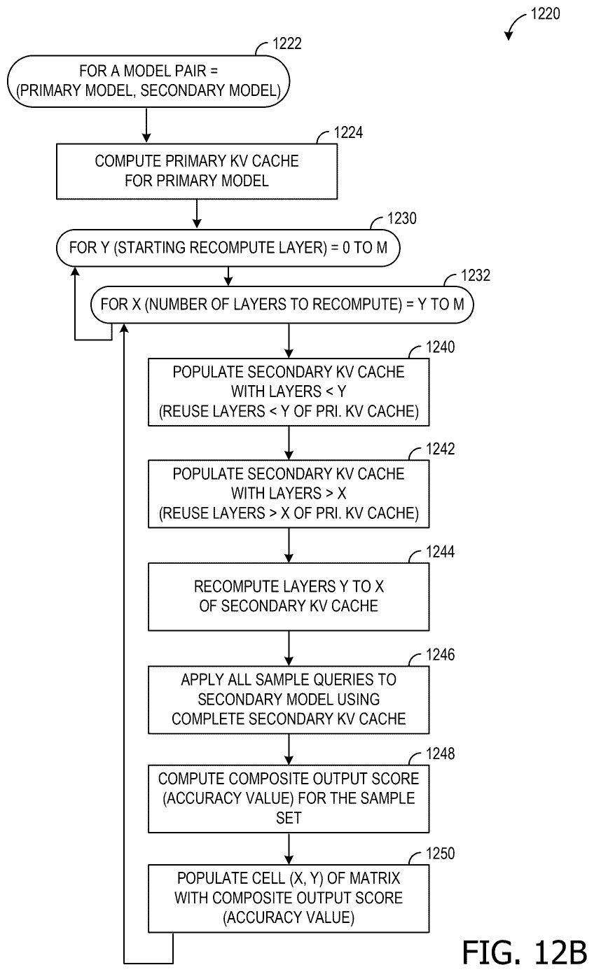

FIG. 12A is a graph 1200 that illustrates an example profiling output for the glue_sst2 and conllpp model pair. In the example, the profiler 142 generates the graph 1200 during a profiling stage (e.g., prior to implementing reuse patterns 144 and the sharing of KV cache data between agent services 110). For simplicity, the graph 1200 shows only an example reuse→recompute→reuse pattern. Results are shown for glue_sst2 (e.g., as a fine-tuned model) reusing the KV cache of conllpp (e.g., as the base model) on HotpotQA, where the darker the color, the higher the quality of the generation output (e.g., higher accuracy value 1218, as depicted by accuracy meter 1206). Each cell 1210 of the graph 1200 shows the accuracy achieved for different configurations of the reuse→recompute→reuse pattern. The layer number Y on the y-axis 1204 indicates the layer at which recomputing begins, while the layer number X on the x-axis 1202 indicates the layer at which recomputing stops. As such, for any given cell 1210 having a particular X and Y coordinate in the matrix 1200, the profiler 142 builds a secondary KV cache 1214 by reusing layers from a primary KV cache (not shown in FIG. 12A) for layers below layer Y and layers above layer X, but recomputes layers between Y and X of the secondary KV cache 1214, as depicted in operation 1212. These operations result in a “composite” secondary KV cache 1214 for each particular cell that includes some reused layers from the primary cache (e.g., layers <Y and layers >X, for the given X, Y coordinates of the particular cell) and some recomputed layers (e.g., layers Y to X). Accordingly, using that composite secondary KV cache 1214 for that particular X, Y cell 1210, the profiler 140 computes an accuracy value 1218 for that cell 1210 at operation 1216 (e.g., storing that accuracy value 1218 in that particular cell 1210).

Trending toward the diagonal of the plot is optimal for efficiency (e.g., larger Y values and smaller X values), as it minimizes the number of prefill recomputations while maintaining high accuracy. Based on the example graph 1200 and pattern shown in FIG. 12A, the cells within the red-boxed region represent optimal configurations. Among these, the system 100 select the leftmost cell in the red region, which involves recomputing layers 13 to 23, achieving near-optimal accuracy while maximizing efficiency.

In some examples, the profiler 142 identifies one or more reuse patterns 144 based on the graph 1200. In some embodiments, the profiler 142 identifies cells 1210 of the graph 1200 that have an accuracy value 1218 that exceed an accuracy threshold. From that subset of cells 1210, the profiler 142 selects the cell 1210 that has the least number of recomputed layers (e.g., where the number of recomputed layers is Y-X for a given cell 1210). In situations of a tie in number of recomputed layers, the profiler 142 selects the cell with the highest accuracy value 1218. In some embodiments, the profiler 142 applies a weight (a “recomputed layers weight”) to the accuracy value 1218 of the cells 1210 (e.g., the subset of cells that exceed the accuracy threshold), where the weight is inversely proportional to the number recomputed layers (e.g., a higher weight for lower numbers of recomputed layers). As such, the profiler 142 selects the cell with the highest weighted accuracy value, perhaps causing the selection of a cell that has more recompute layers but a significantly higher accuracy value than another cell that has less recompute layers but a lower accuracy value.

In some examples, the profiler 142 shares the graph 1200 with one or more of the agent services 110A, 110B (e.g., the first agent host device 112A as the sharing host, the second agent host device 112B as the receiving host), and the host device 112 identifies the reuse pattern 144. In some embodiments, the profiler 142 or the host device 112 uses real-time performance factors, additionally or alternatively, to select the reuse pattern 144 based on the graph 1200. In an example, the receiving host device (e.g., second agent host device 112B) receives the graph 1200 from the profiler 142 and dynamically selects the reuse pattern 144 using the graph 1200 based on computational system utilization currently being experienced by the host device 112B (e.g., CPU utilization, load average, latency, memory utilization, disk or network I/O wait time, context switching, process queue length, interrupt rate, thread contention, or the like, or some higher-order load metric such as queries per second or the like). In scenarios of lower or lighter utilization, the host device 112B can afford to perform more computations (e.g., more layers of recompute) as compared to when the host device 112B is experiencing heavier loads. As such, the host device 112B applies a “performance weight” to the “recomputed layers weight” (described above), where the performance weight is higher when the system load is higher (thereby increasing the impact of the recomputed layers weight, causing greater chance of selecting of a cell with a lower number of layers to be recomputed) and where the performance weight is lower when the system load is lower (thereby reducing the impact of the recomputed layers weight, causing greater chance of selecting a cell with higher accuracy but a higher number of layers to be recomputed).

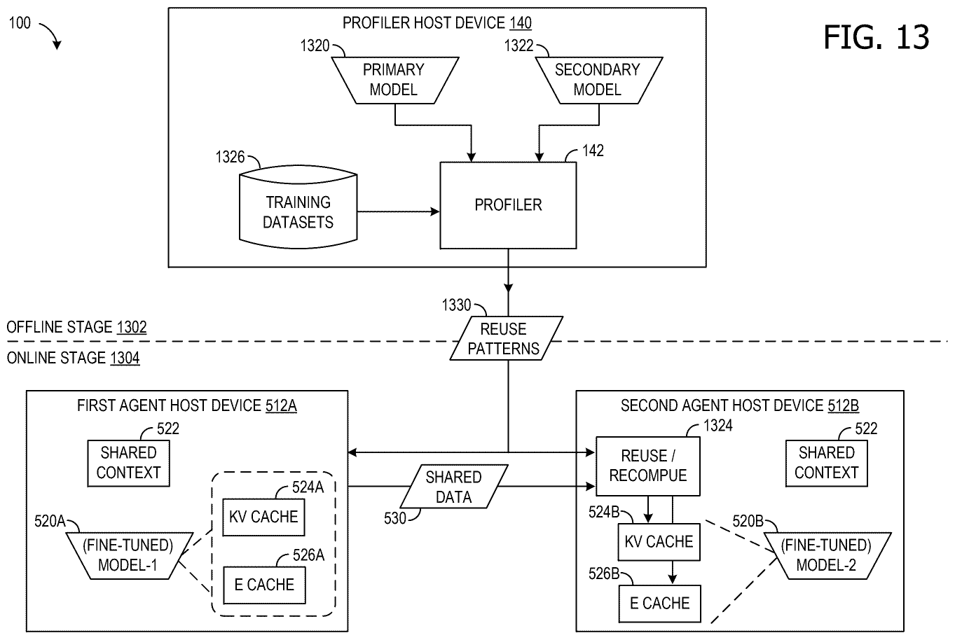

FIG. 12B is a flowchart 1220 illustrating example operations for generating the graph 1200 shown in FIG. 12A, along with associated accuracy values 1218 for the cells 1210 of the graph 1200. In some examples, the operations are performed by the profiler host device 140 shown in FIG. 13, using model-1 120A as the “primary model” and model-2 120B as the “secondary model.” In the example, at loop 1222, the profiler host device 140 identifies a model pair that includes a primary model (e.g., the model that shares portions of its KV cache, referred to herein as the primary KV cache) and a secondary model (e.g., the model that reuses portions of the primary KV cache when constructing its own KV cache, referred to herein as the secondary KV cache).

At operation 1224, the profiler host device 140 computes the primary KV cache for the primary model. This primary KV cache is used to “reuse” some layers when repeatedly building secondary KV caches described below. For these examples, it is presumed that both the primary KV cache and the secondary KV cache include M layers, and thus the dimensions of the matrix shown in graph 1200 is an M-by-M matrix. At loop 1230, the profiler host device 140 loops for Y=0 to M, where Y is the starting layer at which to begin recomputing layers of the secondary KV cache. At loop 1232, the profiler host device 140 loops for X=0 to N, where X is the number of layers to recompute (starting at layer Y). As such, each (X, Y) represents a cell 1210 of the diagonal matrix shown in the graph 1200 of FIG. 12A, where the secondary KV cache for that particular reuses layers <Y and layers >X from the primary KV cache, but recomputes layers Y to X of the secondary KV cache, as described below.

For example, for each loop iteration, the profiler host device 140 performs a sequence of operations configured to compute a value for that (X, Y) cell of the matrix. At operation 1240, the profiler host device 140 populates the secondary KV cache with all layers <Y from the primary KV cache. These are the “reuse layers” that are effectively copied from the primary KV cache to the secondary KV cache into layers <Y. At operation 1242, the profiler host device 140 also populates the secondary KV cache with all layers >X from the primary KV cache (also “reuse layers”). At operation 1244, the profiler host device 140 recomputes the remaining layers of the secondary KV cache (e.g., all of the layers not copied from the primary KV cache in operation 1240 and 1242), namely layers Y to X. As such, all layers of the secondary KV cache are populated by either operation 1240 and 1242 (reused) or operation 1244 (recomputed).

Once the secondary KV cache is created for this (X, Y) iteration, the profiler host device 140 applies all sample queries to the secondary model at operation 1246, which is using that secondary KV cache. Each of these sample queries generates an output that is compared to a benchmark value (e.g., a ground truth for that sample) based on evaluation criteria for that particular sample. At operation 1248, the profiler host device 140 computes a composite output score for the sample set (e.g., a composite metric value indicating how accurate the various sample outputs were, the accuracy value 1218 for this particular cell 1210). In some examples, this composite output score incorporates one or more of an accuracy metric (e.g., how accurate the outputs were) and a re-computation metric (e.g., how much recomputing was needed relative to reuse for this (X, Y) iteration, the recomputed layers weight). In examples, the composite output score is a pareto frontier of accuracy and efficiency/latency, where accuracy is measured using the scoring mechanisms that come with the benchmarks used (e.g., F1score). At operation 1250, the (X, Y) cell of the matrix is populated with this composite output score.

Accordingly, the matrix for any given pair of models is populated. This matrix effectively represents a heat map identifying how well or poorly a particular segment of reused KV cache impacts accuracy and/or computational efficiency. While the example illustrates only a single segment of reuse, it should be understood that the profiler host device 140 may similarly evaluate two or more segments of reuse.

FIG. 13 is an architecture diagram that supplements the context sharing system 100 shown in FIG. 1. As illustrated in the example shown in FIG. 13, the design of the context sharing system 100 includes two main stages: an offline stage 1302 for profiling a reuse pattern 144 (e.g., used to determine what data will be the shared data 130 of FIG. 1) and an online stage 1304 in which portions of a context are shared between agents (e.g., host devices 112A, 112B), thereby causing a partial recomputation within a dynamic workload (e.g., on the receiving agent, host device 112B, based on the reuse pattern 144).

More specifically, in the example, during the offline stage 1302, the profiler host device 140 (e.g., the profiler 142) performs profiling on a model pair including a primary model 1320 and a secondary model 1322. This model pair is profiled using a training dataset 1326 to find the accuracy-efficiency Pareto-optimal curve of reuse patterns (e.g., as shown and described in FIG. 12). The profiler 142 dynamically choose the reuse pattern 144 based on available resources. In examples, the reuse pattern 144 includes a list of three integers to denote recompute→reuse→recompute→reuse. By increasing reuse during high-load periods, the system 100 can prioritize throughput by minimizing computational overhead, while during low-load periods for requests with enough slack in latency SLOs, recomputation can be emphasized to maintain higher accuracy.

During the online stage 1304, the context sharing system 100 (e.g., reuse/recompute 1324) dynamically determines, from the reuse patterns 144, which point in the Pareto-frontier should be used (e.g., based on a latency SLO or the like). The primary model (e.g., model-1 120A on the first agent host device 112A) stores the E cache for transition points, and transfers KV cache as per the current reuse pattern to the second agent host device 112B (e.g., as shared data 130). The reuse/recompute 1324 on the second agent host device 112B uses the shared data 130 to populate portions of the KV cache 124B of model-2 120B and selectively recomputes the other layers (e.g., the non-reused layers, based on the chosen reuse pattern 144), thereby achieving a balance between computational efficiency and accuracy.

In some examples, the first agent host device 112A transmits all of the KV cache 124A of model-1 120A (e.g., the primary model in this relationship, the model sharing data with a downstream model) and the second agent host device 112B determines which layers to reuse and which layers to recompute for model-2 120B (e.g., the secondary model in this relationship, the model reusing some data from the upstream model) based on the identified reuse pattern 144. In other examples, the first agent host device 112A identifies which layers will be reused (e.g., via the identified reuse pattern 144) and transmits only those layers of the primary KV cache 124A as the shared data 130, thereby minimizing the amount of data transmitted between the two host devices 112A, 112B.

The separation of profiling and runtime phases allows for adaptability across diverse datasets and task requirements, making the context sharing system 100 a robust solution for efficient LLM inference. In examples, portions of the context sharing system 100 (e.g., profiler 142, reuse/recompute 1324) is implemented in Python, based on PyTorch v2.0, CUDA 12.0, and LMCache 0.1.3. The context sharing system 100 operates LLM inference serving engines through the following three interfaces: store_kv (KVCache, context, LLM), store_e (ECache, context, LLM), where the KV or E cache are split into layers and stored in a key-value store in GPU memory; fetch_kv (context, LLM, layer_id)→KVCache, fetch_e (context, LLM, layer_id)→ECache, which loads the KV or E cache of the corresponding model for that specific layer_id; and partial_prefill (recompute_config, context)→text, which takes in the recomputation configuration and the context, including which layers to recompute during prefill, and then generates the output text. These three interface in HuggingFace and LMCache. For store_kv, after an LLM generates the KV cache for a piece of context, the profiler 142 includes calculating the hash of the context text, and putting it into the key-value store if the context does not exist in the current store. Before the inference for any model is ran, the agent host device(s) 112A, 112B obtain the reuse pattern 144 for the particular pair of primary/secondary models from the profiler host device 140, which includes the layer numbers for recompute and KV cache reuse. During the online inference stage, the partial_prefill function is called, which calls fetch_kv for the layers for KV cache reusing, and fetch_e at the transition layers. Both fetch_kv and fetch_e are implemented with torch.distributed to fetch KV cache from a remote GPU node.

Several notable observations from the evaluation are: Across three datasets and eight model pairs, the context sharing system 100 can reduce the prefill latency by 1.7 to 2.6 times without significantly compromising accuracy; In the online stage 1304, the context sharing system 100 achieves up to 3 times improvement in throughput; and the profiling of recomputing layers is robust across different datasets and model types.

### Experiments

The context sharing system 100 is evaluated on eight pairs of models (e.g., see Table 1) of different sizes, specifically the fine-tuned versions of Mistral-7B, Llama-3-8B, Phi-3.5-mini and Llama-3.1-70B. These models are fine-tuned on the base foundation model for math reasoning tasks, chat-enhancing tasks, and long context reasoning, et. al. Regarding hardware settings, the experiments are executed on two A100 virtual machines in Microsoft Azure, namely Standard_ND96amsr_A100_v4, which contain 8 80 GB A100 GPUs on each virtual machine, and are connected with InfiniBand link. Regarding datasets 1326, the experiment evaluates the context sharing system 100 on three different datasets, which consists of 650 contexts in total, and the statistics of the context lengths are shown below in Table 2. The tasks are aimed to test the model's ability in multiple-hop reasoning and multiple-field reasoning from LongBench evaluation suite.

TABLE 2
Size and Context Lengths of Datasets in Experiments

| Dataset | Size | Med. | Std. | P95 |
|---|---|---|---|---|
| hotpotQA | 400 | 10933 | 5160 | 18650 |
| 2wikimQA | 200 | 7466 | 3976 | 10705 |
| miltifieldQA_en | 150 | 8084 | 3849 | 14680 |

Regarding train/test split, as discussed above, the context sharing system 100 profiles the minimal block size that maintains accuracy with a “training” dataset offline (e.g., during offline phase 1302). Specifically, in examples, 50 contexts from HotpotQA dataset are used as the “training” dataset, and the block size chosen by this training dataset is used on other datasets in this benchmark. For HotpotQA, the other 250 contexts are used to test in the evaluation section. Regarding quality metrics, the context sharing system 100 measures generation quality using the standard metric of each dataset. In examples, F1 score is used, which measures the probability that the generated answer matches the ground-truth answer for the question-answering task. Regarding system metrics, the context sharing system 100 uses the system metrics listed above to evaluate results compared with the baselines, including TTFT, TBT, E2E. The context sharing system 100 also measures prefill latency, which includes the prefill computation time on GPU and the loading delay to fetch KV and E cache through InfiniBand bandwidth link across two GPU nodes.

Regarding baselines, the context sharing system 100 uses the following baselines for comparison: Full prefill: the receiver model (e.g., secondary model 1322, model-2 120B) prefills the text of the context with vLLM, which represents the baseline of the highest computation overhead but the best quality achievable; Full KV cache reuse: the receiver model directly reuses the KV cache from the sender model (e.g., primary model 1320, model-1 120A), and the receiver model runs decoding with the transferred KV cache; and Smaller models: comparison of Llama-3.1-70BInstruct's accuracy and latency trade-off with the context sharing system 100 with Llama-3.1-8B-Instruct, which is fine-tuned with the same instruct-tuning dataset.

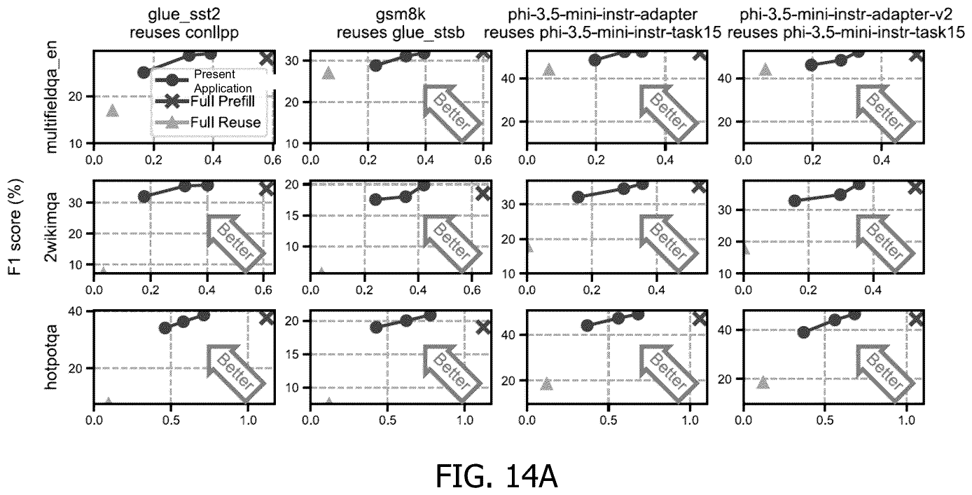

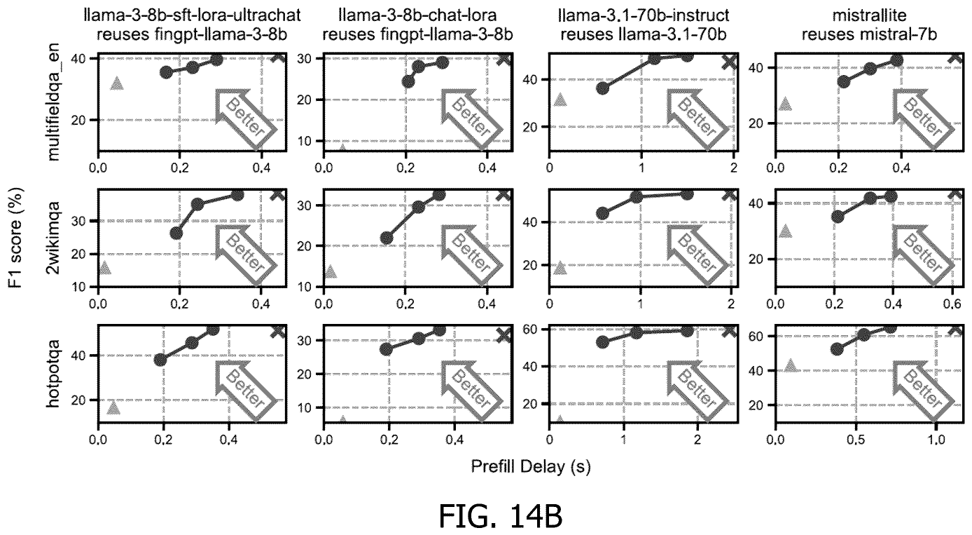

FIG. 14A and FIG. 14B illustrate experimental results for evaluating context sharing between various pairs of models under the context sharing system 100 of FIG. 1 and FIG. 13. In the experiments, the context sharing system 100 demonstrates reduction in prefill delay and accuracy trade-off. Across eight pairs of models on three datasets, the context sharing system 100 achieves 1.7-2.6× reduction in prefill delay over the full prefill method, without compromising generation quality. On the other hand, when compared with reusing all of sender model's KV cache, the context sharing system 100 successfully preserves the improved quality of the receiver model despite a slightly higher delay.

The context sharing system 100 outperforms the baselines for various reasons. Compared to the full prefill baseline, the context sharing system 100 achieves significantly lower prefill delay as only a small fraction of layers is prefilled. In contrast to full KV reuse, the context sharing system 100 has a longer prefill latency because it does not perform prefill at all. However, it greatly reduces accuracy because it misses the opportunity to leverage layer-wise sensitivity in the KV cache.

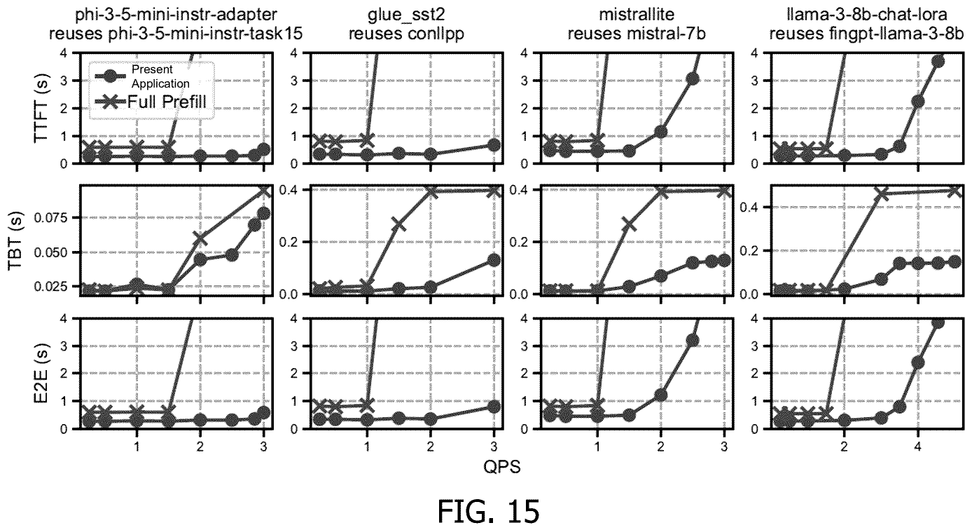

FIG. 15 illustrates the impact of arrival rate on time-to-first-token (TTFT), time-between-tokens (TBT), and end-to-end latency (E2E) when the context sharing system 100 quality is same as full prefill. To see the impact of the context sharing system 100 on improving the throughput of an online LLM inference system, the experiment simulated an online inference scenario by pairing the datasets with request arrival times following uniform distribution under different incoming rates to evaluate the performance of the context sharing system 100 in more practical workloads.

As demonstrated in FIG. 15, the TTFT, TBT, and E2E impact are compared under various request rates on HotpotQA dataset with four pairs of models. For the context sharing system 100, the configuration within 1% accuracy drop for these pairs of models was chosen. Regarding TTFT, since the full-recompute baseline has around 2x higher prefill latency than the context sharing system 100, the queuing delay affects (knee in the curve) its TTFT at a much lower QPS than what the context sharing system 100 can support. Regarding TBT and E2E, although the experiment is only reducing the TTFT directly in the context sharing system 100, the second-degree effect through less interference and better scheduling brings down the TBT and E2E latency too, as shown in FIG. 15. Regarding throughput, assuming an SLO that avoids the effects of high queuing delays on TTFT, TBT, and E2E latency, the context sharing system 100 can support 2-3× higher throughput as shown in the FIG. 15.

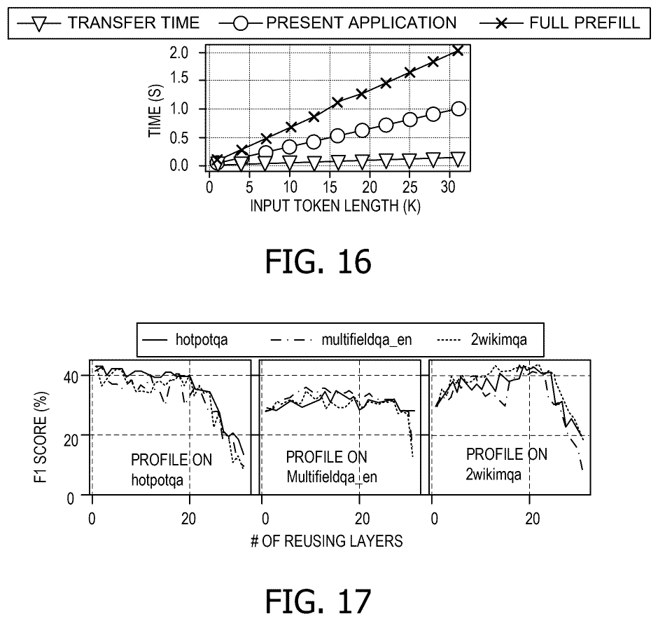

FIG. 16 illustrates the impact of context length to the prefill latency of the context sharing system 100 and the loading delay to fetch KV and E cache. The context sharing system 100, in examples, moves the context (e.g., KV cache and E cache) from the baseline model to the specialized model. To demonstrate the overheads incurred by this transfer with increasing context length, FIG. 16 presents the prefill latency using the model pair glue_sst2 and conllpp on the HotpotQA dataset. It is observed that across different input lengths, the context sharing system 100 consistently reduces the prefill latency by half. This consistent improvement occurs because the context sharing system 100 skips the prefill computation using the same reuse pattern, resulting in a proportional latency reduction regardless of the input context size. Furthermore, the loading delay to fetch KV and E cache from another GPU node that is interconnected with InfiniBand link is very low, taking up only at max 11% of total prefill delay, which can be overlapped with compute through further optimizations.

FIG. 17 illustrates using the recompute layers profiled on training datasets. As discussed above, the context sharing system 100 profiles the KV cache reuse pattern using a single profiling run on a “training dataset” during the offline stage and then generalizes the profile results to other datasets during the online stage. FIG. 17 illustrates whether the profile obtained on one dataset offline generalizes well to other datasets. In each subfigure, the Pareto frontier of the F1 score versus the number of reused layers is plotted, which is obtained through profiling on the original testing dataset vs two other datasets in this benchmark using glue_sst2 and conllpp model pair. FIG. 17 also demonstrates that the Pareto frontier obtained using the profile from the training dataset on the testing dataset closely resembles the frontier obtained using the profile directly from the testing dataset. Across all the pertinent configurations, the maximum difference in the score is 4 points, with the average being 2 points. This result further validates the sufficiency and robustness of the described profiling strategy.

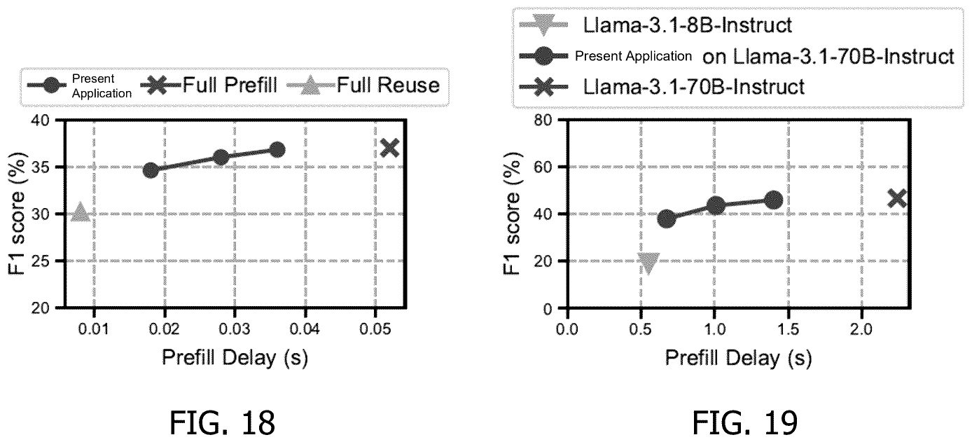

FIG. 18 illustrates prefill delay and accuracy trade-off for MAmmoTH2 (fine-tuned for math reasoning tasks). So far, results are presented above on 3 QA benchmarks from Long-Bench. To demonstrate that the mechanisms of the context sharing system 100 applies broadly to other types of models and datasets as well, the experiment applies the context sharing system 100 on a model pair where the specialized model is fine-tuned on math reasoning, and tested on a task that aims to test LLM's ability in math problem-solving. More specifically, in FIG. 18, GSM8K dataset is ran on MAmmoTH2. Note that the Pareto frontier obtained follows a very similar pattern compared to the LongBench models and dataset, demonstrating the wide applicability of the context sharing system 100.

FIG. 19 illustrates the context sharing system 100 as applied on Llama-3.1-70B-Instruct having higher accuracy than Llama-3-8B-Instruct. Since the context sharing system 100 trades off minimal accuracy impact with latency, the context sharing system 100 is compared on a larger model with a smaller model of the same architecture to show the superior performance in quality and delay trade-off. More specifically, FIG. 19 compares the context sharing system 100 on Llama-3.1-70Binstruct and Llama-3.1-8B-Instruct, which is a smaller version of Llama-3.1-70B-Instruct and fine-tuned on the same dataset to enhance the base LLM's ability to follow instructions. As shown, Llama-3.1-8B achieves approximately a 4× reduction in prefill delay but suffers a reduction in F1 score of about half compared to the original F1 score of Llama-3.1-70B-Instruct.

One significant drawback of using a smaller model to achieve speedup is the overhead of switching between small and large models. For example, when additional resources become available, switching back to the larger model to improve serving quality incurs the overhead of loading the larger model back onto the GPU, which can degrade system throughput. In contrast, the context sharing system 100 easily adapts to the available compute resources by adjusting the number of layers to be recomputed. This enables more possibilities in efficient scaling up or down on demand.

In some examples, the context sharing system 100 only recomputes a subset of layers, further reducing latency. In some examples, regarding reduction in power and energy, the prefill phase is much more power-intensive than the decode phase. Decode-heavy tasks in fact, can be run on lower power hardware, since they are memory-bound rather than compute-bound. Since the context sharing system 100 drastically reduces the prefill phase, it is used to reduce energy and power of the overall system. In some examples, regarding using KV cache compression, the context sharing system 100 integrates the described approach with KV compression techniques to further reduce memory and transmission costs. Regarding models with different foundational models, the context sharing system 100 extends the described approach to scenarios where models do not share the same foundational model, including integrating techniques to align and adapt intermediate representations across structurally different models.

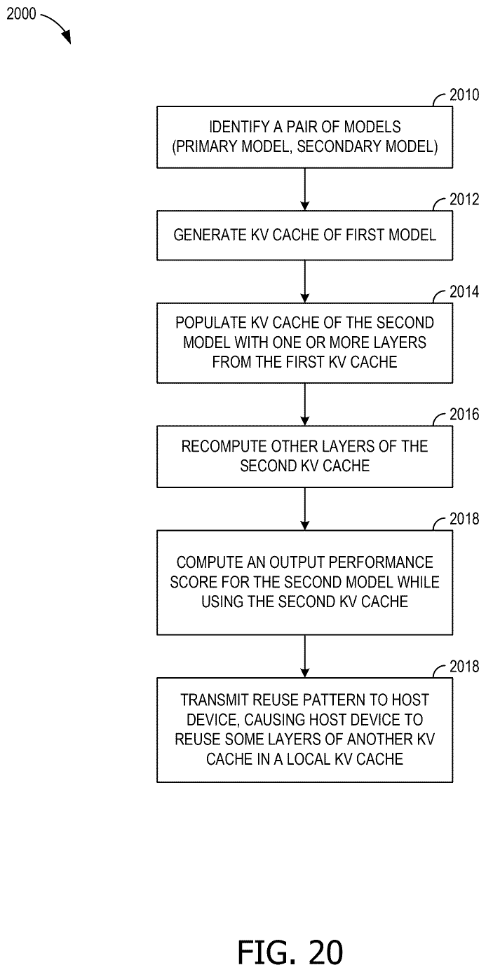

FIG. 20 is a flowchart of an example method 2000 for context sharing between generative artificial intelligence (GAI) models. In some examples, some or all of the operations of the method 2000 are performed by the profiler host device 140 or one or more agent host devices (e.g., agent host devices 112A, 112B). In the example, at operation 2010, the profiler host device 140 identifies a pair of GAI models including a first model (e.g., primary model 1320) and a second model (e.g., secondary model 1322). In some examples, the first model and the second model are fine-tuned variants of a baseline model.

In the example, at operation 2012, the profiler host device 140 generates a first key-value (KV) cache of the first model, the first KV cache including a plurality of first KV cache layers. At operation 2014, the profiler host device 140 populates a second KV cache of the second model with one or more layers of the first KV cache layers. At operation 2016, the profiler host device 140 recomputes one or more other layers of the second KV cache. At operation 2018, the profiler host device 140 generates an output performance score for the second model based on comparison between (a) at least one output generated by the second model while using the second KV cache and (b) a baseline metric. In some examples, computing the output performance score is a composite score generated by: submitting a plurality of test samples to the second model, thereby generating a plurality of sample outputs; scoring each sample output of the plurality of sample outputs relative to a baseline metric, thereby generating a plurality of sample output scores, and calculating the output performance score based on the plurality of sample output scores. In some examples, generating an output performance score is further based on one or more of (a) an accuracy metric comparing an output of the second model with a ground truth and (b) a computational savings metric representing an amount of computation reduced by reusing the one or more layers of the first KV cache layers in the second KV cache.

At operation 2020, in the example, the profiler host device 140 transmits a reuse pattern (e.g., reuse patterns 144) to a host device (e.g., agent host devices 112A, 112B) for use in context sharing between an instance of the first model (e.g., model-1 120A) and an instance of the second model (e.g., model-2 120B), the reuse pattern identifying the plurality of first KV cache layers to be reused, thereby causing the host device to generate a local KV cache (e.g., KV cache 124B) for the instance of the second model by reusing the plurality of first KV cache layers from a KV cache (e.g., KV cache 124A) of the instance of the first model.

In some examples, the profiling host device 140 also generates a matrix of output performance scores, the matrix including a first axis representing a reuse start layer and a second axis representing a quantity of layers to reuse, each cell in the matrix being associated with a particular reuse start layer and a particular quantity of layers to reuse; and for each cell in the matrix, computing another output performance score for a particular cell using the associated reuse start layer and the associated quantity of layers to reuse of that cell, wherein generating the other output performance score includes populating the second KV cache with the associated quantity of layers from the first KV cache starting at the associated reuse start layer and recomputing one or more other layers of the second KV cache.

In some examples, the profiling host device 140 also receives, at a first agent (e.g., first agent host device 112A) executing the instance of the first model (e.g., model 120A), a reuse pattern (e.g., reuse patterns 144) identifying the one or more layers of the first KV cache layers, transmits, from the first agent to a second agent (e.g., second agent host device 112B), the one or more layers of the instance of the first model based on the reuse pattern (e.g., as shared data 130), receives, at the second agent executing the instance of the second model (e.g., model-2 120B), the one or more layers of the instance of the first model, populates the local KV cache (e.g., KV cache 124B) of the instance of the second model using the one or more layers of the instance of the first model, and recomputes all other layers of the local KV cache of the instance of the second model.

### Additional Examples

An example context sharing system comprises: at least one processor; and a memory comprising computer-readable instructions, the at least one processor, the memory and the computer-readable instructions configured to cause the at least one processor to: identify a pair of generative artificial intelligence (GAI) models including a first model and a second model; generate a first key-value (KV) cache of the first model, the first KV cache including a plurality of first KV cache layers; populate a second KV cache of the second model with one or more layers of the first KV cache layers; recompute one or more other layers of the second KV cache; generate an output performance score for the second model based on comparison between (a) at least one output generated by the second model while using the second KV cache and (b) a baseline metric; and transmit a reuse pattern to a host device for use in context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model.

An example computerized method for context sharing between GAI models comprises: identifying a pair of GAI models including a first model and a second model; generating a first KV cache of the first model, the first KV cache including a plurality of first KV cache layers; populating a second KV cache of the second model with one or more layers of the first KV cache layers; recomputing one or more other layers of the second KV cache; computing an output performance score for the second model based on comparison between (a) at least one output generated by the second model while using the second KV cache and (b) a baseline metric; and transmitting a reuse pattern to a host device for use in context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model.

An example computer storage medium having computer-executable instructions that, upon execution by a processor of a computer, cause the processor to at least: identify a pair of GAI models including a first model and a second model; generate a first KV cache of the first model, the first KV cache including a plurality of first KV cache layers; populate a second KV cache of the second model with one or more layers of the first KV cache layers; recompute one or more other layers of the second KV cache; generate an output performance score for the second model based on comparison between (a) at least one output generated by the second model while using the second KV cache and (b) a baseline metric; and transmit a reuse pattern to a host device for use in context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model.

Alternatively, or in addition to the other examples described herein, examples include any combination of the following:
identifying a pair of GAI models including a first model and a second model;
one or more of the first model and the second model are LLMs;
generating a first key-value (KV) cache of the first model;
the first KV cache including a plurality of first KV cache layers;
populating a second KV cache of the second model with one or more layers of the first KV cache layers;
recomputing one or more other layers of the second KV cache;
recomputing all other layers of the second KV cache not populated with layers from the first KV cache layers;
computing an output performance score for the second model based on comparison between (a) at least one output generated by the second model while using the second KV cache and (b) a baseline metric;
transmitting a reuse pattern to a host device;
the reuse pattern is used in context sharing between an instance of the first model and an instance of the second model;
the reuse pattern identifying the plurality of first KV cache layers to be reused;
causing a host device to generate a local KV cache for an instance of the second model;
reusing the plurality of first KV cache layers from a KV cache of the instance of the first model in the local KV cache;
submitting a plurality of test samples to the second model, thereby generating a plurality of sample outputs;
scoring each sample output of the plurality of sample outputs relative to a baseline metric, thereby generating a plurality of sample output scores;
calculating the output performance score based on the plurality of sample output scores;
generating a matrix of output performance scores;
the matrix including a first axis representing a reuse start layer;
the matrix including a second axis representing a quantity of layers to reuse;
each cell in the matrix being associated with a particular reuse start layer and a particular quantity of layers to reuse;
for one or more cells in the matrix, computing another output performance score for a particular cell using the associated reuse start layer and the associated quantity of layers to reuse of that cell;
generating the other output performance score includes populating the second KV cache with the associated quantity of layers from the first KV cache starting at the associated reuse start layer and recomputing one or more other layers of the second KV cache;
generating an output performance score is based on an accuracy metric comparing an output of the second model with a ground truth;
generating an output performance score is based on a computational savings metric representing an amount of computation reduced by reusing the one or more layers of the first KV cache layers in the second KV cache;
receiving, at a first agent executing the instance of the first model, a reuse pattern identifying the one or more layers of the first KV cache layers;
transmitting, from the first agent to a second agent, the one or more layers of the instance of the first model based on the reuse pattern;
receiving, at the second agent executing the instance of the second model, the one or more layers of the instance of the first model;
populating the local KV cache of the instance of the second model using the one or more layers of the instance of the first model;
weighting the other output performance score based on a system load metric of a computing device;
recomputing all other layers of the local KV cache of the instance of the second model; and
the first model and the second model are fine-tuned variants of a baseline model.

While the aspects of the disclosure have been described in terms of various examples with their associated operations, a person skilled in the art would appreciate that a combination of operations from any number of different examples is also within scope of the aspects of the disclosure.

### Exemplary Operating Environment

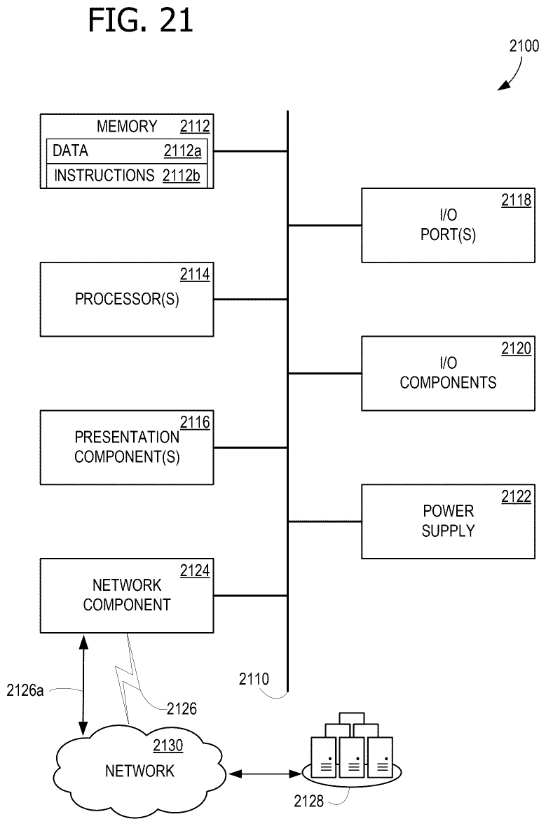

FIG. 21 is a block diagram of an example computing device 2100 (e.g., a computer storage device) for implementing aspects disclosed herein, and is designated generally as computing device 2100. In some examples, one or more computing devices 2100 are provided for an on-premises computing solution. In some examples, one or more computing devices 2100 are provided as a cloud computing solution. In some examples, a combination of on-premises and cloud computing solutions are used. Computing device 2100 is but one example of a suitable computing environment that can be used in the described system and is not intended to suggest any limitation as to the scope of use or functionality of the examples disclosed herein, whether used singly or as part of a larger set. Neither should computing device 2100 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 2100 includes a bus 2110 that directly or indirectly couples the following devices: computer storage memory 2112, one or more processors 2114, one or more presentation components 2116, input/output (I/O) ports 2118, I/O components 2120, a power supply 2122, and a network component 2124. While computing device 2100 is depicted as a seemingly single device, multiple computing devices 2100 may work together and share the depicted device resources. For example, memory 2112 may be distributed across multiple devices, and processor(s) 2114 may be housed with different devices.

Bus 2110 represents what may be one or more busses (such as an address bus, data bus, or a combination thereof). Although the various blocks of FIG. 21 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 21 and the references herein to a “computing device.” Memory 2112 may take the form of the computer storage media referenced below and operatively provide storage of computer-readable instructions, data structures, program modules and other data for the computing device 2100. In some examples, memory 2112 stores one or more of an operating system, a universal application platform, or other program modules and program data. Memory 2112 is thus able to store and access data 2112a and instructions 2112b that are executable by processor 2114 and configured to carry out the various operations disclosed herein.

In some examples, memory 2112 includes computer storage media. Memory 2112 may include any quantity of memory associated with or accessible by the computing device 2100. Memory 2112 may be internal to the computing device 2100 (as shown in FIG. 21), external to the computing device 2100 (not shown), or both (not shown). Additionally, or alternatively, the memory 2112 may be distributed across multiple computing devices 2100, for example, in a virtualized environment in which instruction processing is carried out on multiple computing devices 2100. For the purposes of this disclosure, “computer storage media,” “computer-storage memory,” “memory,” and “memory devices” are synonymous terms for the computer-storage memory 2112, and none of these terms include carrier waves or propagating signaling.

Processor(s) 2114 may include any quantity of processing units that read data from various entities, such as memory 2112 or I/O components 2120. Specifically, processor(s) 2114 are programmed to execute computer-executable instructions for implementing aspects of the disclosure. The instructions may be performed by the processor, by multiple processors within the computing device 2100, or by a processor external to the client computing device 2100. In some examples, the processor(s) 2114 are programmed to execute instructions such as those illustrated in the flow charts discussed below and depicted in the accompanying drawings. Moreover, in some examples, the processor(s) 2114 represents an implementation of analog techniques to perform the operations described herein. For example, the operations may be performed by an analog client computing device 2100 and/or a digital client computing device 2100. Presentation component(s) 2116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 2100, across a wired connection, or in other ways. I/O ports 2118 allow computing device 2100 to be logically coupled to other devices including I/O components 2120, some of which may be built in. Example I/O components 2120 include, for example but without limitation, a microphone, joystick, game pad, satellite dish, scanner, printer, wireless device, etc.

Computing device 2100 may operate in a networked environment via the network component 2124 using logical connections to one or more remote computers. In some examples, the network component 2124 includes a network interface card and/or computer-executable instructions (e.g., a driver) for operating the network interface card. Communication between the computing device 2100 and other devices may occur using any protocol or mechanism over any wired or wireless connection. In some examples, network component 2124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 2124 communicates over wireless communication link 2126 and/or a wired communication link 2126a to a remote resource 2128 (e.g., a cloud resource) across network 2130. Various different examples of communication links 2126 and 2126a include a wireless connection, a wired connection, and/or a dedicated link, and in some examples, at least a portion is routed through the internet.

Although described in connection with an example computing device 2100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A context sharing system comprising:
a processor; and
a memory comprising computer-readable instructions, the processor, the memory and the computer-readable instructions configured to cause the processor to:
identify a first model and a second model;
generate a first key-value (KV) cache of the first model, the first KV cache including a plurality of first KV cache layers;
populate a second KV cache of the second model with one or more layers of the first KV cache layers;
recompute one or more other layers of the second KV cache;
generate an output performance score for the second model based on comparison between (a) an output generated by the second model while using the second KV cache and (b) a baseline metric; and
configure a host device with a reuse pattern for context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model.

2. The context sharing system of claim 1, wherein the instance of the first model is configured to reason about the cause of a detected anomaly as part of a cybersecurity system, wherein the host device is configured to execute the instance of the second model to generate a recommended action for the detected anomaly.

3. The context sharing system of claim 1, wherein the output performance score is a composite score generated by:
submitting a plurality of test samples to the second model, thereby generating a plurality of sample outputs;
scoring each sample output of the plurality of sample outputs relative to a baseline metric, thereby generating a plurality of sample output scores; and
calculating the output performance score based on the plurality of sample output scores.

4. The context sharing system of claim 1, wherein the processor, the memory and the computer-readable instructions are further configured to cause the processor to:
generate a matrix of output performance scores, the matrix including a first axis representing a reuse start layer and a second axis representing a quantity of layers to reuse, each cell in the matrix being associated with a particular reuse start layer and a particular quantity of layers to reuse; and
for one or more cells in the matrix, generate another output performance score for a particular cell using the associated reuse start layer and the associated quantity of layers to reuse of that cell, wherein generating the other output performance score includes populating the second KV cache with the associated quantity of layers from the first KV cache starting at the associated reuse start layer and recomputing one or more other layers of the second KV cache.

5. The context sharing system of claim 1, wherein generating an output performance score is further based on one or more of (a) an accuracy metric comparing an output of the second model with a ground truth and (b) a computational savings metric representing an amount of computation reduced by reusing the one or more layers of the first KV cache layers in the second KV cache.

6. The context sharing system of claim 1, wherein the processor, the memory and the computer-readable instructions are further configured to cause the processor to:
receive, at a first agent executing the instance of the first model, a reuse pattern identifying the one or more layers of the first KV cache layers;
transmit, from the first agent to a second agent, the one or more layers of the instance of the first model based on the reuse pattern;
receive, at the second agent executing the instance of the second model, the one or more layers of the instance of the first model;
populate the local KV cache of the instance of the second model using the one or more layers of the instance of the first model; and
recompute all other layers of the local KV cache of the instance of the second model.

7. The context sharing system of claim 1, wherein the first model and the second model are fine-tuned variants of a shared baseline model.

8. A computerized method for context sharing between generative artificial intelligence (GAI) models, the method comprising:
populating a KV cache of a model with a layer of another KV cache generated by another model;
recomputing another layer of the KV cache;
computing an output performance score for the model based on comparison between (a) an output generated by the second model while using the KV cache and (b) a baseline metric; and
transmitting a reuse pattern to a host device for context sharing between an instance of the model and an instance of the other model, the reuse pattern identifying the layer to be reused by the instance of the model, thereby causing the host device to generate a local KV cache for the instance of the model by reusing the layer from the instance of the other model.

9. The method of claim 8, wherein the output performance score is a composite score generated by:
submitting a test sample to the model, thereby generating a sample output;
scoring the sample output relative to a baseline metric, thereby generating a sample output score; and
calculating the output performance score based on the sample output score.

10. The method of claim 8, further comprising:
generating a matrix of output performance scores, the matrix including a first axis representing a recompute start layer and a second axis representing a quantity of layers to recompute, each cell in the matrix being associated with a particular recompute start layer and a particular quantity of layers to recompute; and
for each cell in the matrix, computing another output performance score for a particular cell using the associated recompute start layer and the associated quantity of layers to recompute of that cell, wherein generating the other output performance score includes recomputing layers starting at the recompute start layer and for the associated quantity of layers, and populating the KV cache with the other layers from the other KV cache.

11. The method of claim 10, wherein computing another output performance score for a particular cell further includes weighting the other output performance score based on a system load metric of a computing device.

12. The method of claim 8, wherein generating an output performance score is further based on one or more of (a) an accuracy metric comparing an output of the model with a ground truth and (b) a computational savings metric representing an amount of computation reduced by reusing the one or more layers of the other KV cache layers in the KV cache.

13. The method of claim 8, further comprising:
receiving, at a first agent executing the instance of the other model, a reuse pattern identifying the layer of the other KV cache;
transmitting, from the first agent to a second agent, the layer of the instance of the first model based on the reuse pattern;
receiving, at the second agent executing the instance of the model, the one or more layers of the instance of the other model;
populating the local KV cache of the instance of the model using the one or more layers of the instance of the other model; and
recomputing all other layers of the local KV cache of the instance of the model.

14. The method of claim 8, wherein the model and the other model are fine-tuned variants of a baseline model.

15. A computer storage medium having computer-executable instructions that, upon execution by a processor of a computer, cause the processor to at least:
identify a pair of generative artificial intelligence (GAI) models including a first model and a second model;
generate a first key-value (KV) cache of the first model, the first KV cache including a plurality of first KV cache layers;
populate a second KV cache of the second model with one or more layers of the first KV cache layers;
recompute one or more other layers of the second KV cache;
generate an output performance score for the second model based on comparison between (a) output generated by the second model while using the second KV cache and (b) a baseline metric; and
configure a host device with a reuse pattern for context sharing between an instance of the first model and an instance of the second model, the reuse pattern identifying the plurality of first KV cache layers to be reused, thereby causing the host device to generate a local KV cache for the instance of the second model by reusing the plurality of first KV cache layers from a KV cache of the instance of the first model.

16. The computer storage medium of claim 15, wherein the output performance score is a composite score generated by:
submitting a plurality of test samples to the second model, thereby generating a plurality of sample outputs;
scoring each sample output of the plurality of sample outputs relative to a baseline metric, thereby generating a plurality of sample output scores; and
calculating the output performance score based on the plurality of sample output scores.

17. The computer storage medium of claim 15, wherein the instructions further cause the processor to:
generate a matrix of output performance scores, the matrix including a first axis representing a reuse start layer and a second axis representing a quantity of layers to reuse, each cell in the matrix being associated with a particular reuse start layer and a particular quantity of layers to reuse; and
for one or more cells in the matrix, generate another output performance score for a particular cell using the associated reuse start layer and the associated quantity of layers to reuse of that cell, wherein generating the other output performance score includes populating the second KV cache with the associated quantity of layers from the first KV cache starting at the associated reuse start layer and recomputing one or more other layers of the second KV cache.

18. The computer storage medium of claim 17, wherein computing another output performance score for a particular cell further includes weighting the other output performance score based on a system load metric of a computing device.

19. The computer storage medium of claim 15, wherein generating an output performance score is further based on one or more of (a) an accuracy metric comparing an output of the second model with a ground truth and (b) a computational savings metric representing an amount of computation reduced by reusing the one or more layers of the first KV cache layers in the second KV cache.

20. The computer storage medium of claim 15, wherein the instructions further cause the processor to:
receive, at a first agent executing the instance of the first model, a reuse pattern identifying the one or more layers of the first KV cache layers;
transmit, from the first agent to a second agent, the one or more layers of the instance of the first model based on the reuse pattern;
receive, at the second agent executing the instance of the second model, the one or more layers of the instance of the first model;
populate the local KV cache of the instance of the second model using the one or more layers of the instance of the first model; and
recompute all other layers of the local KV cache of the instance of the second model.
